(19) United States
(12) Patent Application Publication
(10) Pub. No.: US 2019/0231638 A1
(43) Pub. Date: Aug. 1, 2019

(54) Strap with Abdominally Worn Base Plate for Sex Toy

(71) Applicant: Austin Madore, Mulberry, FL (US)

(72) Inventor: Austin Madore, Mulberry, FL (US)

(21) Appl. No.: 15/885,364

(22) Filed: Jan. 31, 2018

(51) Int. Cl. A61H 19/00

(52) U.S. Cl. CPC A61H 19/44; A61H 2201/1652; A61H 2201/163

(57) ABSTRACT

The present invention relates to a device for affixing a sex toy to the abdominal area of a human being. Specifically, the present invention relates to a strap with an abdominally worn base plate for affixing a sex toy such as a dildo leaving the genitals of the wearer exposed.

### CROSS-REFERENCE TO RELATED APPLICATIONS

Not applicable.

### FIELD OF THE INVENTION

The present invention relates to a device for affixing a sex toy to the abdominal area of a human being. Specifically, the present invention relates to a strap with an abdominally worn base plate for affixing a sex toy such as a dildo leaving the genitals of the wearer exposed.

### BACKGROUND OF THE INVENTION

Currently there is a universal method for affixing a dildo to a human being for sexual use: A dildo is affixed to a base plate worn over the pubic area of the wearer. A locating strap system surrounds the waist and legs of the wearer and holds the base on the human wearer in the pubic area. This means of wearing a dildo and strap apparatus positions the base of the dildo at or about the level of the mons pubis. When worn by a female this presents few problems. But, when worn by a male the base of the dildo impinges on the male genitalia. This can be painful.

What is needed then is a strap and base for a dildo or other sex toy that may be worn such that the base on which the dildo or sex toy is mounted supra-pubicly above the pubic area of the wearer.

Also what is needed is a strap and base for a dildo or other sex toy that has a relatively large, flat base so that the force of using a dildo or other sex toy is distributed out to the relatively soft supra-pubic area of the wearer.

Also what is needed is a strap and base for a dildo or other sex toy that has an open space for the penis and testicles of the wearer such that the penis and testicles are exposed.

Also what is needed is a strap and base for a dildo or other sex toy that has adjustable straps so that the device may be comfortably worn by different individuals.

Also what is needed is a strap and base for a dildo or other sex toy that has a user changeable base for mounting a dildo or other sex toy.

### SUMMARY OF THE INVENTION

The exemplary embodiment of the present invention comprises the following components: 1) A strap assembly for attaching or affixing a dildo or other sex toy to the abdomen of the user; and, 2) A changeable mounting facility for affixing the dildo or sex toy to the strap assembly.

The strap assembly for attaching or affixing a dildo or other sex toy to the abdomen of the user is comprised of a base plate placed supra-pubicly above the genitals of the wearer. Attached to the back and sides of the base plate is the front strap. The front strap terminates with holes for receiving the tang of a buckle affixed to one end of each of the side straps. Each side strap also comprises a metal loop with a rear strap affixed between them. Proceeding down from the truncate bottom end of the base plate are the initial parts of two lower straps. The initial parts of the two lower straps terminate in buckles with a tang. Halfway along the length of the initial parts of the two lower straps are a linear series of holes formed in each. The initial parts of the two lower straps are crossed over and affixed together by placing a pin or other fixing device through mated holes in the initial parts of the two lower straps. The exact location where the initial parts of the two lower straps are crossed and affixed together may be varied and are generally set by the wearer to supply tension after the penis and testicles are inserted. The ends of the two lower straps end in buckles with tangs which are coupled to the terminal portions of the two lower straps. The other end of the terminal portions of the two lower straps are affixed to the two loops mentioned previously.

The exemplary embodiment of the present invention is used in the following manner: First, the user places the waist strap (comprising the front strap, the side straps, and the rear strap) around the waist such that the base plate is positioned supra-pubicly on the soft tissue of the abdomen. Next, the user then adjusts the waist strap such that that the waist strap is securely tensioned around the waist. Next, the user places his penis and testicles through the opening formed by the lower edge of the base plate and the crossed lower straps. The user may be wearing a penile restraint device. Next, the user draws the lower straps between the legs and up over the buttocks and affixes the terminal portion of each of them through the loops in the rear of the waist strap. Next, the user tightens the buckles in the lower straps so that the lower straps are securely fixed to his lower body. Finally, the user affixes a dildo or other sex toy to the base plate by means of the changeable mounting facility on the base plate of the strap assembly.

### BRIEF DESCRIPTION OF THE DRAWINGS

FIG. 1 is a view of the top (away from the skin) surface of the present invention.

FIG. 2 is a three-quarter view of the present invention assembled as worn.

FIG. 3 is a three-quarter view of the present invention with a dildo attached as is worn by a male.

### DETAILED DESCRIPTION OF THE PREFERRED EMBODIMENT

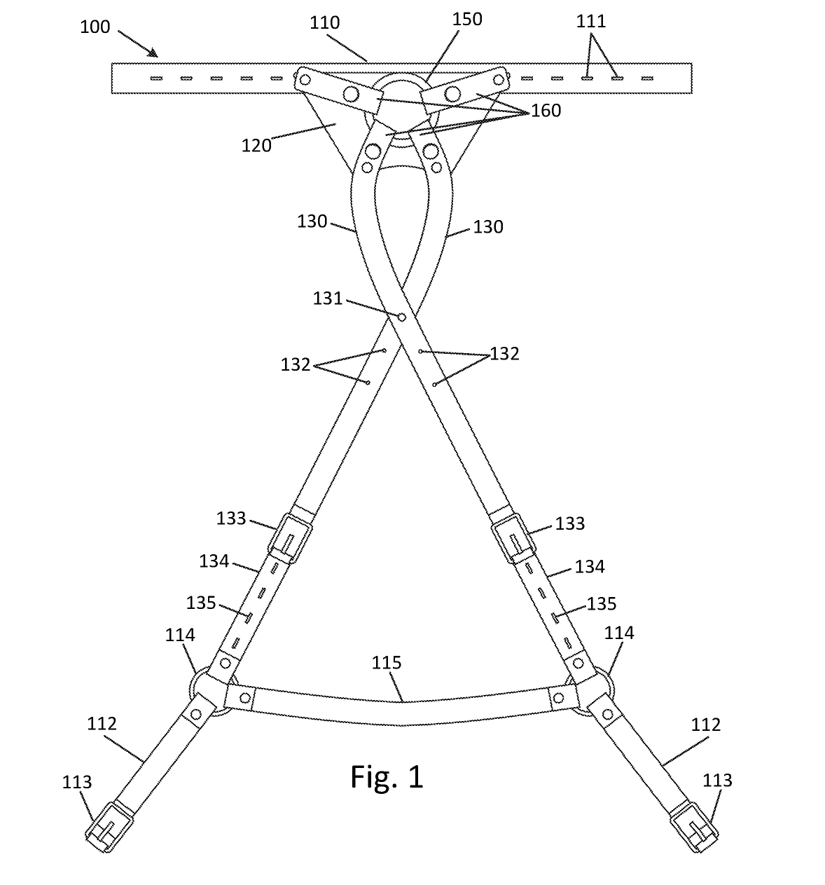

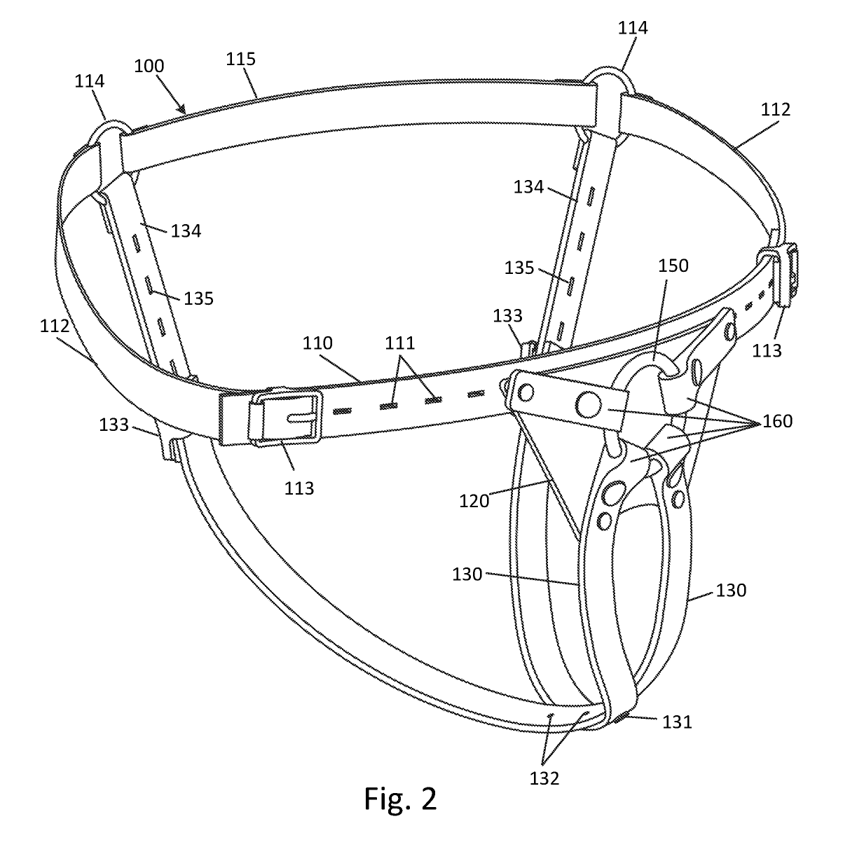

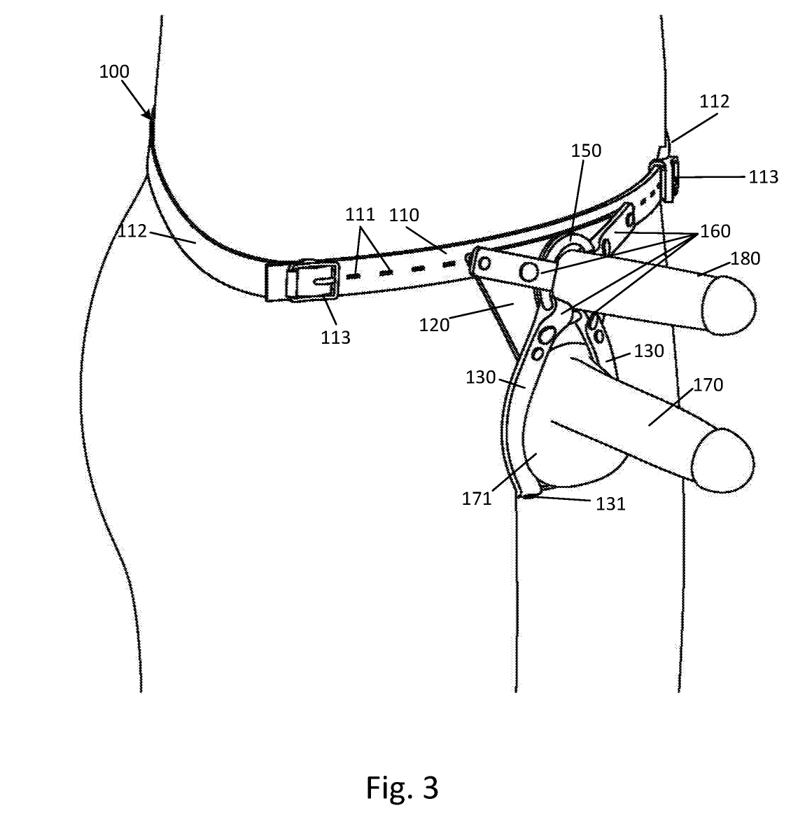

Referring now to FIGS. 1, 2, and 3, the exemplary embodiment of the present invention 100 comprises the following components: 1) A strap assembly 100 for attaching or affixing a dildo or other sex toy to the abdomen of the user further comprising: a) A waist worn, horizontally disposed waist strap comprising a front strap 110 with holes 111, side straps 112 each with buckles 113 where the opposite ends of the side straps are affixed to metal loops 114, and rear strap 115 affixed between two metal loops 114; b) A truncate base plate 120 horizontally affixed at its broad top portion to the horizontally disposed front strap 110; and, c) The initial portions of at least two lower straps 130 each one affixed to the truncate bottom portion of the base plate 120 wherein the two initial portions of the at least two lower straps 130 are joined by a clip or a rivet 131 affixed through two holes 132 overlaid approximately four inches from where they are affixed to the base plate 120. The at least two initial portions of lower straps 130 each have a series of holes 132 punched or otherwise formed in them. A clip or rivet 131 passes through two holes 132 overlaid on top of one another. Of course, the user has the option of using any set of holes 132 in both lower straps 130 to fasten lower straps 130 together, so the distance between bottom portion of the base plate 120 and the point at which two lower straps 130 are joined together by a clip or a rivet 131 affixed through two holes 132 ranges from about three inches to about five inches from where they are affixed to the base plate 120.

The crossed, connected at least two initial portions of lower straps 130 then proceed rearward between and over the buttocks of the wearer up to attach by means of buckles 133 or other affixing devices attached to holes 135 punched or otherwise formed in the terminal portions of lower straps 134 by means of buckles 133. The unbuckled end of each terminal portion of lower strap 134 is affixed to metal loop 114. It will be obvious to those having skill in the art that the unbuckled end of each terminal portion of lower strap 134 may be permanently or removably affixed to metal loop 114.

The changeable mounting facility for affixing dildo 180 or sex toy to base plate 120 of strap assembly 100 is removably affixed to the base plate 120. Specifically, the exemplary embodiment of the present invention has four flexible straps 160 capable of being opened and closed securing ring 150 or other mounting device to base plate 120. Those having skill in the art will recognize that more or less than four flexible straps 160 may be used to secure ring 150. Ring 150 or other mounting device is specifically designed to affix and support a particular dildo 180 or sex toy. Securing ring 150 is merely one example of a system that may be used to secure a dildo 180 or sex toy to base plate 120.

The exemplary embodiment of the present invention is used in the following manner: First, the user places the horizontally disposed front strap 110 around the waist such that base plate 120 is positioned supra-pubicly on the soft tissue of the abdomen. Next, the user adjusts front strap 110 by means of buckles 113 such that that waist strap assembly 100 is securely tensioned around the waist. Next, the user places his penis 170 and testicles 171 through the opening formed by the truncate lower edge of base plate 120 and the crossed initial portions of lower straps 130. It will be obvious to those having skill in the art that the user may place only his penis 170, or testicles 171, independently through the opening formed by the truncate lower edge of base plate 120 and the crossed initial portions of lower straps 130. The user may be wearing a penile restraint device. Next, the user draws the initial portions of lower straps 130 down between the legs and up over the buttocks and affixes each of them to the terminal portions of lower strap 134 by means of buckles 133 with their tangs each inserted in a hole 135. Next, the user tightens buckles 133 such that the entire strap assembly 100 is securely affixed to the lower body. Finally, the user affixes dildo 180 or other sex toy to base plate 120 by means of ring 150 mounted to the changeable mounting facility on base plate 120 of the strap assembly 100. In the exemplary embodiment dildo 180 is secured by the mounting flange at the base of dildo 180.

Of course, it will be obvious that other details regarding the use of the invention may be changed. For example, it will be readily apparent to those having skill in the art that numerous other refinements may be made to the exemplary embodiment of the invention. For example, horizontally disposed front strap 110, side straps 112, rear strap 115, and the at the initial and terminal portions of least two lower straps 130 and 134 may be combined and formed as one elastic strap. All disclosed straps may be replaced by elastic straps without buckles or holes for tangs. Such a strap would be slipped over the lower body and used as described above. Also, it will be readily apparent that the terminal portions of lower strap 130 may be combined as one strap and attached to one metal loop 114 connecting side straps 112. In this case one loop 114 is provided instead of two.

What is claimed is:

1. A strap with an abdominally worn base plate for a sex toy comprising:
a) an abdominally worn base plate further comprising an outwardly mounted toy affixing device;
b) horizontally disposed waist strap with the base plate positioned at its mid portion; and
c) two lower straps proceeding from the truncate lower edge of the base plate down and being joined together and then proceeding up towards, and being attached to, the horizontally disposed waist strap.

2. A strap with an abdominally worn base plate for a sex toy of claim 1 wherein the two lower straps are fastened together about three inches from the base plate.

3. A strap with an abdominally worn base plate for a sex toy of claim 1 wherein the two lower straps are fastened together about four inches from the base plate.

4. A strap with an abdominally worn base plate for a sex toy of claim 1 wherein the two lower straps are fastened together about five inches from the base plate.

5. A strap with an abdominally worn base plate for a sex toy of claim 1 further comprising a dildo attached to the outwardly mounted toy affixing device.

6. A strap with an abdominally worn base plate for a sex toy of claim 1 further comprising at least one width adjusting device such as a buckle in the horizontally disposed waist strap.

7. A strap with an abdominally worn base plate for a sex toy of claim 1 further comprising at least one width adjusting device such as a buckle in each of the lower straps.

8. A method of using a strap with an abdominally worn base plate for a sex toy comprising the following steps:
a) placing the base plate supra-pubicly on the abdomen with the horizontally disposed waist strap proceeding around the waist and the truncate lower edge of the base plate down;
b) placing the genitals in the open area beneath the truncate lower edge of the base plate and between the downwardly aligned lower straps in front of the point where the lower straps are joined together;
c) aligning the lower straps between the buttocks;
d) fastening the lower straps to the waist strap; and
e) affixing a sex toy on the outwardly mounted toy affixing device.

9. A method of using a strap with an abdominally worn base plate for a sex toy of claim 8 wherein the genitals are the penis and testicles.

10. A method of using a strap with an abdominally worn base plate for a sex toy of claim 8 wherein the genitals are the testicles.
